(19) United States
(12) Patent Application Publication
(10) Pub. No.: US 2006/0106697 A1
(43) Pub. Date: May 18, 2006

(54) Systems and methods for network-based design submission and selection

(76) Inventors: Morgan Lynch, Cedar Hills, UT (US); George Willis Dempster IV, Orem, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/989,045

(22) Filed: Nov. 15, 2004

(51) Int. Cl. G06Q 40/00

(52) U.S. Cl. 705/35

(57) ABSTRACT

In a computer network, a client accesses a management services network and submits a request for a design project. Through the management services network, the client views portfolios showing various work products created by designers associated with the management services network. The client then selects designers, based on the design products shown in the designer portfolios, to be members of a design team for the client. After the members of the design team create initial concepts for review by the client, the client selects one designer to create a design product. The selected designer creates the product and receives payment for services rendered.

### BACKGROUND OF THE INVENTION

1. The Field of the Invention

The present invention relates generally to initiation, management, and execution of work projects in a computer network environment. More particularly, embodiments of the present invention relate to systems, methods, and software for use in defining, implementing, and managing relationships between clients and a group of contractors so as to facilitate economically efficient relationships directed to the execution, by the contractors, of work projects defined by the clients.

2. Related Technology

A prevalent problem in a variety of industries is a lack of vehicles or systems to bring widely dispersed production resources to bear on unmet demands of multiple clients. In the design field, for example, there is a relatively steady demand for high quality design work. Correspondingly, there is a demand in the designer community for a stable work load of satisfying and profitable work projects. However, although there is often a suitable supply of designer services, as well as adequate demand for designer services, clients and designers have largely been unable to match their respective demands and services in an economically satisfactory and efficient manner. For example, although a client can obtain design services from a single designer with relative ease, it is often difficult for a client to obtain services from multiple designers due to logistical and cost concerns.

One approach to ameliorating client and designer concerns by providing clients better access to designers, and providing designers better access to clients, has been to take advantage of the communication capabilities of a computer network environment, such as the Internet. Communication environments, such as the Internet, generally eliminate the need for personal, physical interaction between clients and designers, thus enabling the formation of relationships between clients and designers that could not exist in other circumstances.

Although computer network environment have been helpful in connecting clients and designers, significant problems remain with regard to this work management and execution model. Use of a computer network as the sole communication medium between a client and a designer limits the ability to monitor design services and to ensure that clients receive quality products. In addition, problems can arise with regard to how clients will pay for services and how designers will receive remuneration.

From the client perspective, a variety of problems are implicated by processes relating to solicitation, execution, and management of work projects identified by the client. For example, the process of solicitation of bids from designers can prove tedious, time consuming, and overly burdensome to the client. Moreover, most clients may lack the skills and knowledge to perform a thorough evaluation of bids received.

Not only are difficulties associated with evaluating bids received for a certain project, clients generally have no way to determine whether or not a particular designer or contractor is competent to perform the work required by the client. The bidding process generally provides the client with no way of evaluating the abilities of designers and contractors bidding on the project.

After selecting a designer to work on the project, the client may have additional problems in bringing sufficient pressure to bear on the designer to ensure the work is completed within a set time frame. Likewise, it may be difficult for the client to ensure that the final product is of sufficient quality. In general, the inherently passive nature of systems connecting clients and designers over a communication network provides no effective mechanism for resolving any disputes that may arise between the client and the contactor.

Problems and concerns unique to the contractor or designer perspective are also prevalent in such systems and methods. For example, although a contractor or designer may receive projects through a network based management model, the contractor or designer will often obtain less than her desired volume of work. Furthermore, contractors may also have concerns relating to compensation mechanisms. In the event of a dispute between the contractor and the client, the contractor may have little or no leverage in obtaining full or even partial payment. Furthermore, while the contractor may submit several proposals for designs to the client, with each proposal representing several hours of work, the contractor will be unable to recoup any of the expenses incurred in developing the design proposals in the event the client ultimately chooses the design of another contractor.

Although many of these problems can be solved by a work management system which efficiently manages interactions between clients and designers, some clients prefer a relatively higher level of involvement in the process than typical work management systems allow. Client involvement in some work management systems consists of providing a project request and guiding revisions to proposals received from contractors participating in the work management system. Often, due to limited client involvement, the final product created by designers associated with the work management system is unsatisfactory to the client.

One factor that contributes to these types of problems is that a client typically has little or no control over the makeup of the group of designers. For example, the client may know little or nothing about a designer who will be involved on the client project. A related concern is that the client typically does not have the capability to freely select a desired number of designers for the client project. That is, the client is typically compelled to work with a predetermined group having a limited number of designers. Because only a limited number of designers can work on the client project, thus giving the client only a few proposals from which to choose, there is a risk that the client may not be satisfied by any of the proposals.

Therefore, although the work management system manages the interactions between clients and designers, clients may still desire a higher level of involvement so as to better ensure that they will receive a final product that is satisfactory. Embodiments of the present invention overcome these problems by providing a way for clients to more actively participate in aspects of the work management process.

### BRIEF SUMMARY OF AN EXEMPLARY EMBODIMENT OF THE INVENTION

Embodiments of the present invention relate to work management systems that facilitate efficient and effective transactions between designers and clients in a computer network environment. More particularly, embodiments of the present invention provide a way for increased client involvement in choosing the designers who will work on a project requested by the client. By allowing increased involvement by clients, embodiments of the invention implement an efficient method for ensuring that clients receive satisfactory products from designers through the work management system.

Designers interact with the work management system through the contractor portal connected to the work management system in a computer network. Through the contractor portal, a designer uploads design projects completed by the designer. The designer is then able to manage projects completed by the designer, and ultimately present the projects for display to the client, by way of a designer portfolio. The designer portfolio allows the designer to choose exemplary design projects which the designer has completed and then display the projects in a format accessible by the client. The portfolio in effect represents the resume of the designer, showing projects completed by the designer on the work management system in order to allow clients to select the designer based on the work displayed by the designer.

In order to view the designer portfolios and to select a group or team of designers to work on a client project request, the client interacts with the work management system through a client portal connected to the work management system in a computer network. A project request generated by the client is submitted to the work management system through the client portal. After submitting the project request, the client accesses the designer portfolios and begins the process of selecting designers to work on the project request. After viewing the portfolio of a designer, the client decides whether or not to select the designer to be part of the design team. If the designer is selected and available, the designer becomes part of the design team for the client project request and begins to develop an initial concept to submit to the client.

As suggested above, the client also has significant latitude with regard to the make up of the design team that will be involved with the client project, since the client is able to select designers based on information personal to that designer, such as the designer portfolio. The ability of the client to assemble a customized design team is further enhanced by the fact that the client is able to select as many designers as the client wishes to participate in the design team. In this way, the likelihood that the client will receive at least one suitable proposal from the design team is significantly improved.

Each designer selected for the design team submits an initial concept to the client. The client then selects one designer from the design team to complete the project request based on the initial concept submitted by the designer. The design process continues as the designer submits drafts of the project to the client, giving the client the opportunity to request revisions as the client deems necessary. When the designer completes the project, the final project is presented to the client through the client portal via the management platform. After the client approves the project and pays for the work done on the project, the client is able to download the completed project.

These and other objects and features of the present invention will become more fully apparent from the following description and appended claims.

### BRIEF DESCRIPTION OF THE DRAWINGS

To further clarify the above and other aspects of exemplary embodiments of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings are not drawn to scale. The invention will be described and explained with additional specificity and detail through the use of the accompanying drawings in which:

FIG. 1 is a schematic view illustrating an exemplary management services network;

FIG. 2 is a schematic diagram representing a designer portfolio on a computer network;

FIG. 3 shows an exemplary graphical user interface for managing a designer portfolio;

FIG. 4 shows an exemplary graphical user interface for facilitating team member selection; and

FIG. 5 is a schematic representation of an exemplary process for design team selection and product completion.

### DETAILED DESCRIPTION OF EXEMPLARY EMBODIMENTS OF THE INVENTION

Exemplary embodiments of the present invention generally relate to work management methods and systems implemented in a computer network and providing for a high level of client involvement. Through the use of a work management platform, designers manage individual portfolios which showcase previous design projects completed by the designer. A client who accesses the work management platform views the designer portfolios and, based on the client needs and interests for a particular project request, the client selects one or more designers or, more generally, contractors, to be members of a design team for the project requested by the client. In exemplary embodiments, the client is able to select as many designers as the client wishes to participate in the design team.

Members of the design team create initial concepts which are presented to the client. The client chooses an initial concept, and the designer of the initial concept finalizes the project which is then paid for by the client. After submitting the project request, the client accesses the designer portfolios and begins the process of selecting designers to work on the project request. After viewing the portfolio of a designer, the client decides whether or not to select the designer to be part of the design team. If the designer is selected and available, the designer becomes part of the design team for the client project request and begins to develop an initial concept to submit to the client.

As suggested above, the client also has significant latitude with regard to the make up of the design team that will be involved with the client project, since the client is able to select designers based on information personal to that designer, such as the designer portfolio. The ability of the client to assemble a customized design team is further enhanced by the fact that the client is able to select as many designers as the client wishes to participate in the design team. In this way, the likelihood that the client will receive at least one suitable proposal from the design team is significantly improved.

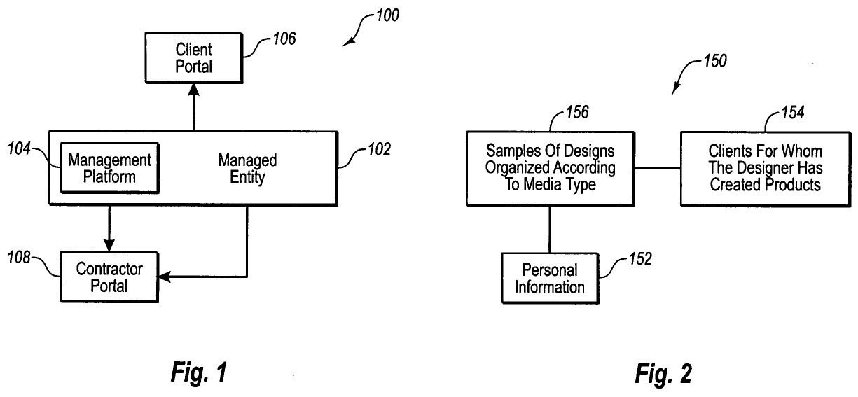

Directing attention now to FIG. 1, details are provided concerning an exemplary management services network (“MSN”) denoted generally at 100. FIG. 1 shows various aspects of exemplary elements of MSN 100, and associated relationships and interactions, such as may be implicated by embodiments of the invention. MSN 100 includes a management entity 102 with a management platform 104 configured and arranged to implement communications with, and between, client portal 106 and contractor portal 108. In at least some implementations, the management entity 102 may likewise be configured for indirect communication with the management platform 104 by way of contractor portal 108. Of course, various other relationships may be defined consistent with the requirements of a particular application.

It should be noted that the configuration of MSN 100 illustrated in FIG. 1 is exemplary only. For example, in some implementations, the management entity 102, the client portal 106, and the contractor portal 108, as well as management platform 104, may all be associated with a single business entity. This may be the case, for example, where the MSN 100 is implemented in the context of a computer network, such as a local area network (“LAN”). In yet another implementation, the management entity 102 may represent, or otherwise be associated with, one particular business entity, while one or both of the client portal 106 and the contractor portal 108 may be associated with one or more other distinct and separate business entities. Consistent with the foregoing, the scope of the invention should not be construed to be limited to any particular implementation of MSN 100.

In general, client portal 106 provides clients with access to management entity 102. By accessing management entity 102 through client portal 106, a client desiring a design product, such as a corporate or business logo, for example, can define a project request that contains information concerning the desires of the client with respect to the logo. In addition to defining a project request, the client views contractor portfolios, by way of client portal 106, contained within management platform 104. By viewing the contractor portfolios, the client is able to assess the design styles and capabilities of various contractors and subsequently select one or more contractors to work on the project requested by the client. The one or more contractors selected by the client constitute the group of contractors the client wants to work on the project requested by the client and are referred to herein as the “team” chosen by the client. Although designers selected by the client to create initial concepts are referred to herein as a team, the designers may work independently to create initial concepts.

After the client has selected a team to work on the project request, the completed project request is transmitted to management platform 104 from client portal 106. After receiving the project request, management platform 104 makes the project request available to the team of contractors selected by the client. The contractors on the team selected by the client, viewing the project request from contractor portal 108, can then decide whether or not to commit to perform the project. In the event that the contractor wishes to perform the project, the contractor then transmits a project commitment to management platform 104 from contractor portal 108.

After receiving the project commitment from the contractor or contractors via contractor portal 108, management platform 104 sets a timetable and other parameters relating to execution of the project. For example, depending on the implementation desired, the management platform could send an email notification to the client informing the client of the contractor acceptance of the project, and/or could send an email to the contractor that contains the timetable. The contractor then completes the project and uploads graphics, or other files, to the management platform 104 where the files are reviewed and a non-downloadable version is then made available to the client by way of client portal 106. When the client has accepted and paid for the product, the management platform 104 then provides the complete file to the client through client portal 106. Depending on the arrangement, the client may have already paid for the product at this point in time or the client may be utilizing a different payment schedule depending on the agreement of the parties involved.

An exemplary work management system and management services network, and associated methods and processes, are more fully disclosed in U.S. patent application Ser. No. 10/371,895, entitled “Systems and Methods for Network-Based Design Submission and Management,” filed Feb. 21, 2003, and U.S. patent application Ser. No. 10/675,356, entitled “Systems and Methods for Network-Based Design Review,” filed Sep. 30, 2003, both of which are wholly incorporated herein by this reference.

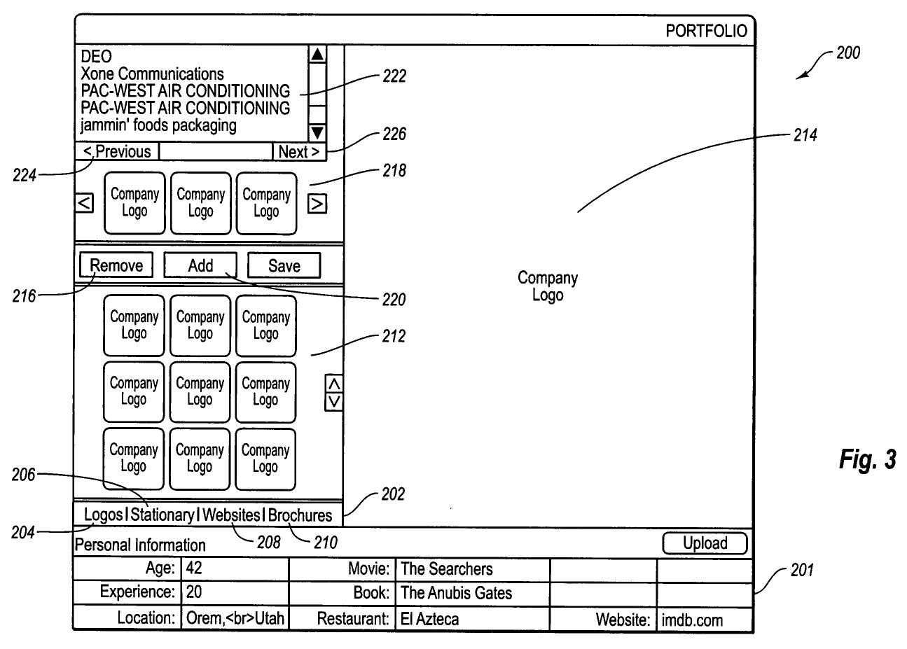

Directing attention now to FIG. 2, a schematic diagram representing a designer portfolio 150 on a computer network is shown. A designer portfolio includes personal information about the designer, such as the name of the designer, the location of the designer, the age of the designer, and the years of experience of the designer, and is shown in FIG. 2 at 152. The portfolio of a designer can also contain a record of clients for whom the designer has created products, as shown at 154. In addition, a designer portfolio can include samples of products created by a designer, with the samples organized according to media type, as shown at 156. For example, samples of logos created by the designer are stored as a collection, while samples of brochures created by the designer are stored as a separate collection. Aspects of the designer portfolio are described in further detail in terms of a portfolio GUI 200 by which designers access the designer portfolios on a computer network, as shown in FIG. 3.

With attention now to FIG. 3, an exemplary portfolio graphical user interface (“GUI”) 200 by way of which the designer manages her portfolio is shown. It is to be appreciated that the content and arrangement of the exemplary portfolio GUI 200 shown in FIG. 3 is exemplary only and the content and arrangement of the portfolio GUI 200 may vary. Exemplary portfolio GUI 200 shows the artwork created by the designer, the clients for whom the designer has created projects, as well as personal information about the designer. Personal information bar 201 contains information about the designer including the name, age, and location of the designer. Through the portfolio GUI 200, the designer is able to edit information in personal information bar 201. The personal information included by the designer will be made available to clients viewing the designer portfolio to aid clients in selecting a suitable designer.

In addition to entering personal information into the portfolio GUI 200, a designer viewing the portfolio may select different products to make available to clients viewing the portfolio of the designer. Through media links 202, the designer selects the media type the designer would like to manage. By selecting the “logos” link 204, the designer can manage various logos created for different clients. By selecting the “stationery” link 206, the designer can manage various stationery designs created by the designer for various clients. Likewise, by selecting the “website” link 208 or the “brochures” link 210, the designer can manage websites or brochures created by the designer for various clients. Embodiments of the present invention should not be construed to be limited to media links 204, 206, 208, and 210 shown in FIG. 3. Other media links which may be included with media links 202, and which correspond to products clients could request from designers, include software written by the designer, audio samples of jingles or other audio recordings created by the designer, videos created by the designer, and any other creative work prepared by the designer for a client. Embodiments of portfolio GUI 200 of the present invention include these and other design products created by designers and which clients could access over a computer network.

When one of links 204, 206, 208, or 210 is selected, a menu 212 showing all the designs created by the designer for that media type is displayed in the portfolio GUI 200. The designer can scroll through vertical scrolling menu 212 and select specific designs which will be displayed in main frame 214. While viewing the artwork contained in menu 212, the designer may desire to add or remove a product from the menu. To remove an item from the menu 212, the designer selects the item and then selects “remove” button 216. To add an item to the menu 212, the designer selects an item from menu 218 and then selects “add” button 220. The item selected from menu 218 will subsequently be added to menu 212. In this way a designer can add or remove design products, or replace existing design products with updated versions of the design.

Although menu 218 contains numerous design products, each design product in the menu 218 corresponds to a client selected in client window 222. For example, if client “A” is selected in client window 222, various designs products created by the designer for client “A” will be displayed in menu 218. When a different client is selected in client window 222, the design products created for that client are displayed in menu 218. If a designer has created design products for numerous clients, “previous” button 224 and “next” button 226 allow the designer to select additional lists of client products. Once the designer has selected her design products that will be displayed in menu 212, the designer saves the selected design projects. The menu 212 thus represents the portfolio of the designer to which clients will have access when selecting designers to become members of a team.

While the designer portfolio is available for editing via portfolio GUI 200 only to designers, clients can access a portion of the portfolio containing information about products created for the particular client. Just as designers can select a client from client window 222 and view all the products created for that client, client “A” can access a collection of all products created for client “A,” either sorted according to a particular designer, or in any other way, such as by product type, date, or cost, for example. Through the stored information concerning products created for the client, a client can view a collection of all the products created for the client by a specific designer in a single location.

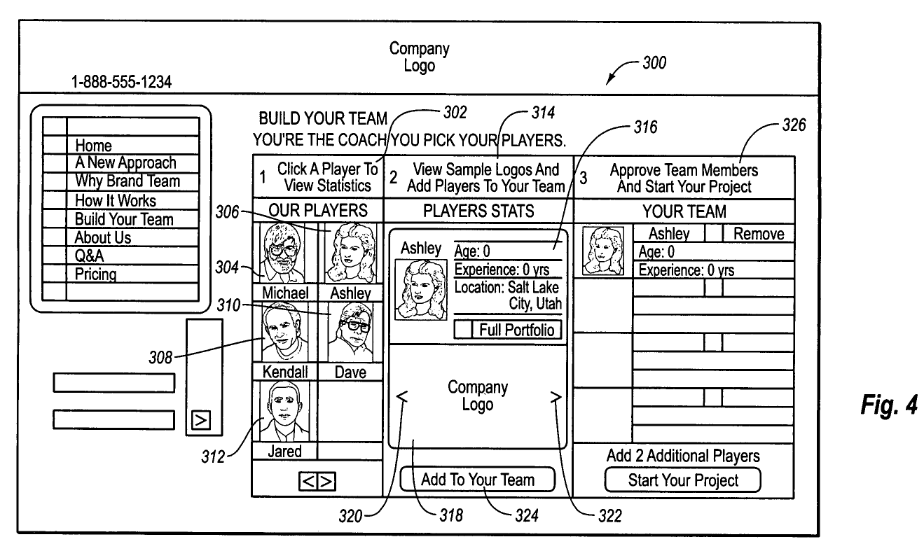

With attention now to FIG. 4, an exemplary GUI 300 for facilitating team member selection is shown. Lineup 302 shows the designers, designated as “players,” associated with the work management platform who are available to work on the project requested by the client. A designer is able to exercise control over her availability to work on projects. For example, if a designer will be on vacation during a certain period of time, the designer may designate that during that period she is unavailable to work on projects. Additionally, designers may have preferences with regard to the type of projects with which the designer would like to be involved. For example, a designer may have a preference for working on animal related designs. According to the preference of the designer, the designer may always be included in lineup 302 if the project requested by the client involves animals. Likewise, a designer may dislike working on projects involving floral designs. Accordingly, when a client requests a project involving floral designs, the designer may not be included in lineup 302.

When lineup 302, showing all available designers, is displayed within GUI 300, each designer picture 304, 306, 308, 310, and 312 and associated name constitute a link to information concerning the designer. When a client selects a designer, information regarding the selected designer is displayed in panel 314. For example, in the exemplary embodiment shown in FIG. 4, the client has selected designer 306 from lineup 302. Information concerning designer 306 is subsequently displayed in panel 314. Information concerning the designer 306 includes, for example, the age, years of experience, and location of the designer, and is displayed in designer profile 316. A client can use the information contained in designer profile 316 to help the client select a designer to work on the project requested by the client. The information available to the client in designer profile 316 corresponds to the personal information entered and edited by the designer in personal information bar 201 of FIG. 3.

While the information contained in designer profile 316 is useful, additional information displayed in panel 314 includes the portfolio of the designer displayed in menu 318. With reference to FIG. 3, considered now in conjunction with FIG. 4, the information compiled in menu 212 created by the designer is viewed in menu 318 by the client. By selecting scrolling arrows 320 and 322, the client can view the portfolio of the designer selected, in this case designer 306. The client can then decide if the abilities of the designer as shown in the portfolio correspond to the preferences of the client for the current product request. If the client wants the designer to be part of the design team, the client selects the “add to your team” button 324, thereby selecting the designer. The designer 306 is then added to the client team column 326.

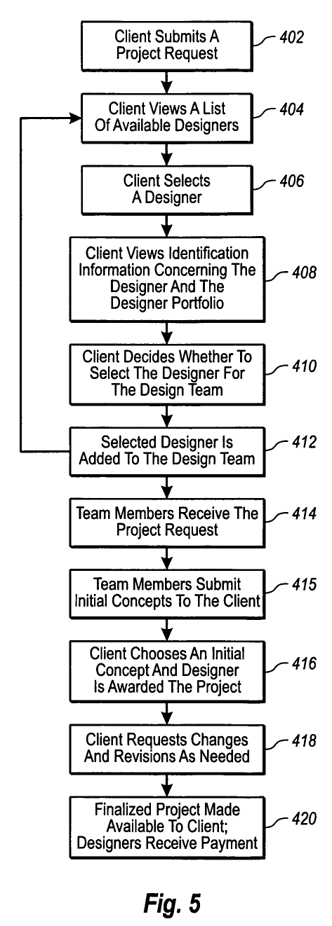

The client can select any number of designers from column 302, view the corresponding designer identification menu(s) and portfolio(s) in column 324, and then select the designer by adding the designer to the team of the client as shown in team panel 326. The number of designers that the client can designate for the design team is unlimited. The designers selected to be part of the team are notified by email, instant message, phone call, fax, or any other method of notification contemplated by the management services network, of the selection made by the client. The price paid by the client for the services provided by the management entity may depend in part upon the number of designers the client selects to be part of the team. The process by which the client submits a project request, selects a design team, and ultimately receives a design product is more particularly shown in FIG. 5.

Although an exemplary GUI showing an exemplary team building system 300 is shown in FIG. 4, the format of team building system 300 should not be construed to limit the scope of the invention. Other methods for allowing clients to view information concerning designers and select designers to be part of a design team of the client are included within the scope of the invention. For example, alternative embodiments such as viewing examples of work done by designers without any personal knowledge about the designer, or viewing examples of work done by a designer which is presented in a format other than a designer portfolio are also contemplated by the present invention.

With attention now to FIG. 5, an exemplary process 400 is illustrated by which designers for a design team are selected and a project request made by a client is completed by one or more members of the design team. The making of a project request is also referred to herein as “submitting a creative brief.” A client can begin the process of receiving a product from a group of designers selected by the client by submitting a project request, or creative brief, as shown at stage 402. Although FIG. 5 shows an exemplary embodiment where a client makes a project request at stage 402, the client may submit the project request after completing the process of selecting designers to be part of the designer team of the client. To select designers to be on the design team of the client, the client views the list of available designers, as shown at stage 404. As noted previously in a discussion of FIG. 4, a designer may determine when the designer will be available to work on projects and may also determine projects for which the designer will be available. After viewing the list of available designers, the client can then scroll through the list of available designers and select a designer, as shown at stage 406. After a designer has been selected, the client may view identification information concerning the designer, and the designer portfolio, as shown at stage 408. At stage 410, the client may or may not select the designer for the design team of the client. If the client selects the designer for the design team of the client, the designer is added to the design team at stage 412. As indicated in FIG. 5, stages 404 through 412 are repeated until all members of the design team have been selected.

Once the members of the design team have been selected, process 400 advances to stage 414 where the team members receive the project request of the client. After reviewing the project request and creating initial concepts based on the project request, team members submit initial concepts to the client, as shown at stage 415. The initial concepts developed by members of the design team are presented to the client as a non-downloadable display, or as a link to a non-downloadable display on the management services network. The client is able to present the non-downloadable display or send the link to the non-downloadable display to family, friends, and colleagues whose opinions the client values in selecting an initial design concept. In this way, the client is able to rely on the opinions of people trusted by the client in making the important decision of which design concept to select. At stage 416, the client chooses the concept the client believes corresponds the best to the project request of the client. Once the client selects a concept, the designer of the initial concept selected by the client is awarded the project requested by the client. During the process of the completion of the project by the designer, the client may request changes and revisions as needed, as shown at stage 418. Finally, at stage 420, the finalized project is made available for download to the client, and the designer and design team receive payment.

Embodiments of the present invention provide a way for designers to showcase their talents in a portfolio available to clients, thereby allowing designers to receive work projects based upon the work abilities of the designer. By creating a way for clients to be involved in selecting designers to work on a project requested by the client, embodiments of the present invention provide a system for creating products in an efficient manner while at the same time providing clients with maximum input and involvement in the product. Additionally, exemplary embodiments of the invention are able to leverage the power of networks, such as the Internet, to bring parties together in efficient transactions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for selecting a product, the method being performed in a computer network that includes a provider site accessible by way of a client portal, and the method comprising:
presenting portfolios by way of the client portal;
receiving selection input corresponding to at least one of the portfolios;
transmitting selection information corresponding to the selection input;
receiving a project request that corresponds with the at least one portfolio for which selection input was received; and
transmitting the project request.

2. The method as recited in claim 1, wherein each of the portfolios is associated with a respective contractor.

3. The method as recited in claim 1, wherein presenting portfolios comprises presenting one or more of: text; graphics; audio; video; software demonstration; written copy sample.

4. The method as recited in claim 1, wherein a portfolio comprises examples of products created by a contractor.

5. The method as recited in claim 1, further comprising receiving and transmitting client logon information.

6. The method as recited in claim 1, further comprising: receiving product selection input; and, transmitting the product selection input.

7. The method as recited in claim 1, wherein selection input is received for more than one portfolio, with each portfolio corresponding to a member of a design team.

8. The method as recited in claim 1, wherein the selection input indicates that a client providing the input wants a contractor associated with the selected portfolio to perform services for the client.

9. The method as recited in claim 1, wherein the project request comprises one of: a creative brief; and, a revision brief.

10. The method as recited in claim 1, further comprising receiving and transmitting acceptance input, wherein the acceptance input indicates that a client has accepted a product.

11. The method as recited in claim 1, further comprising receiving and transmitting payment information.

12. The method as recited in claim 1, further comprising receiving a completed product.

13. The method as recited in claim 1, further comprising presenting a completed product.

14. The method as recited in claim 13, wherein the completed product is one of: text; graphics; audio; video; software; written copy.

15. A method for managing work in a computer network that includes a management platform accessible by way of a client portal, the method comprising:
transmitting portfolios to the client portal;
receiving selection input corresponding to at least one of the portfolios;
receiving a project request;
associating the project request with the selection input; and
transmitting a product associated with the project request and selection input.

16. The method as recited in claim 15, further comprising transmitting multiple contractor initial concepts prior to transmitting a product associated with the project request and selection input.

17. The method as recited in claim 15, wherein the selection input corresponds to members of a design team.

18. The method as recited in claim 15, wherein each of the portfolios comprises examples of products created by respective contractors.

19. The method as recited in claim 15, wherein each of the portfolios is associated with a respective contractor.

20. The method as recited in claim 15, further comprising receiving client logon information and validating the client logon information.

21. The method as recited in claim 15, further comprising receiving revision information concerning the transmitted product.

22. The method as recited in claim 15, further comprising receiving acceptance input corresponding to the transmitted product.

23. The method as recited in claim 15, further comprising receiving payment information.

24. The method as recited in claim 15, wherein the project request comprises a creative brief.

25. The method as recited in claim 15, further comprising transmitting notification to contractors associated, respectively, with selected portfolios.

26. The method as recited in claim 15, wherein the product associated with the project request and selection input is received from a contractor.

27. The method as recited in claim 15, further comprising notifying a client associated with a selected product of completion of the product.

28. The method as recited in claim 15, further comprising receiving input concerning the availability of a contractor to work on the project request.
